(19) United States
(12) Patent Application Publication
(10) Pub. No.: US 2024/0110871 A1
(43) Pub. Date: Apr. 4, 2024

(54) SENSOR CHIP ASSEMBLY AND METHODS TO MANUFACTURE THE SAME

(71) Applicant: Quantum-Si Incorporated, Branford, CT (US)

(72) Inventor: Jonathan C. Schultz, Guilford, CT (US)

(73) Assignee: Quantum-Si Incorporated, Branford, CT (US)

(21) Appl. No.: 18/465,965

(22) Filed: Sep. 12, 2023

Related U.S. Application Data
(60) Provisional application No. 63/406,202, filed on Sep. 13, 2022.

(51) Int. Cl. G01N 21/64

(52) U.S. Cl. CPC G01N 21/6428; G01N 21/6402; G01N 21/645; G01N 2021/6439; G01N 2201/06113; G01N 2201/0636

(57) ABSTRACT

Disclosed herein are embodiments of a sensor chip package that comprises a cap that engages the sensor chip and serving as a helmet that covers some or all of a top surface of the sensor chip. Aspects of the present disclosure provide a cap design that has an optical component to deflect an excitation light signal towards the top surface of sensor chip to excite samples within the sample wells. In some embodiments, the optical component may be a mirror or prism that provides a right angle coupling of excitation light signal to the sensor chip. Some embodiments are directed to a cap design in which a mirror is supported by multiple support surfaces of the cap body such that a mirror of a different length will provide a different tilt angle when supported by the same support surfaces.

### CROSS-REFERENCE TO RELATED APPLICATION

This application claims priority under 35 U.S.C. § 119(e) to U.S. Provisional Patent Application No. 63/406,202, filed on Sep. 13, 2022, which is hereby incorporated by reference in its entirety.

### BACKGROUND

The present disclosure relates generally to integrated devices and device packages for performing massively parallel, quantitative analysis of biological and/or chemical samples, and methods of fabricating said devices.

Detection and analysis of biological samples may be performed using biological assays (“bioassays”). Some bioassays are performed by tagging samples with luminescent markers that emit light of a particular wavelength. The markers are illuminated with a light source to cause luminescence, and the luminescent light is detected with a photodetector to quantify the amount of luminescent light emitted by the markers. Bioassays using luminescent markers conventionally involve expensive laser light sources to illuminate samples and complicated luminescent detection optics and electronics to collect the luminescence from the illuminated samples.

Instruments that are capable of massively-parallel analyses of biological or chemical samples are typically limited to laboratory settings because of several factors that can include their large size, lack of portability, requirement of a skilled technician to operate the instrument, power need, need for a controlled operating environment, and cost. When a sample is to be analyzed using such equipment, a common paradigm is to extract a sample at a point of care or in the field, send the sample to the lab and wait for results of the analysis. The wait time for results can range from hours to days.

Some instruments and related integrated devices can perform massively-parallel analyses of samples by providing short optical pulses to tens of thousands of sample wells or more simultaneously and receiving fluorescent signals from the sample wells for sample analyses. The instruments may be useful for point-of-care genetic sequencing and for personalized medicine.

### SUMMARY

Disclosed herein are embodiments of a sensor chip package that comprises a cap that engages the sensor chip and serving as a helmet that covers some or all of a top surface of the sensor chip. Aspects of the present disclosure provide a cap design that has an optical component to deflect an excitation light signal towards the top surface of sensor chip to excite samples within the sample wells. In some embodiments, the optical component may be a mirror or prism that provides a right angle coupling of excitation light signal to the sensor chip. Some embodiments are directed to a cap design in which a mirror is supported by multiple support surfaces of the cap body such that a mirror of a different length will provide a different tilt angle when supported by the same support surfaces.

Some embodiments are directed to an apparatus that comprises a chip comprising a plurality of sample wells; and a cap disposed on the chip and comprising an optical component configured to direct an excitation light signal for exciting samples within the plurality of sample wells of the chip.

Some embodiments are directed to a cap configured to engage a chip comprising a plurality of sample wells. The cap comprises a cap body; and a mirror configured to deflect an excitation light signal for exciting samples within the plurality of sample wells of the chip.

Some embodiments are directed to a system for sequencing a sample. The system comprises a chip having a sample well configured to hold the sample; a light source configured to produce an excitation light signal; and a cap disposed on the chip and comprising a mirror configured to direct the excitation light signal for exciting the sample within the sample well.

Some embodiments are directed to a method of manufacturing a cap configured to engage a chip having a plurality of sample wells. The method comprises providing a cap body; and placing a mirror in the cap body, such that the mirror is configured to direct an excitation light signal for exciting samples within the plurality of sample wells of the chip.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing. The patent or application file contains at least one drawing executed in color. Copies of this patent or patent application publication with color drawing(s) will be provided by the Office upon request and payment of the necessary fee.

FIG. 1A is a block diagram of an integrated device and an instrument, according to some embodiments.

FIG. 1B is cross-sectional schematic diagram of an integrated device, in accordance with some embodiments.

FIG. 1C is a block diagram depiction of an analytical instrument that includes a compact mode-locked laser module, according to some embodiments.

FIG. 1D shows a compact mode-locked laser module incorporated into an analytical instrument, according to some embodiments.

FIG. 1E shows an example of parallel reaction chambers that can be excited optically by a pulsed laser via one or more waveguides according to some embodiments.

FIG. 2A is a perspective view schematic diagram of an exemplary chip package, in accordance with some embodiments.

FIG. 2B is a top-view schematic diagram of the exemplary chip package shown in FIG. 2A.

FIG. 2C is a perspective-view schematic diagram of the chip package shown in FIG. 2A, with the cap being made partially transparent to illustrate the relationship between the cap and the sensor chip within the chip package.

FIG. 2D is a cutaway perspective view diagram of the chip package of FIG. 2B illustrating the relationship between the mirror and the sensor chip.

FIG. 2E is a side view diagram along the X direction of the chip package of FIG. 2B.

FIG. 2F is a partial-cross sectional view diagram of the chip package of FIG. 2B, with annotations illustrating the right angle coupling of incoming excitation light signal using a mirror in the cap.

FIG. 3A is a high level side view diagram of a mirror supported by multiple support surfaces in a cap body, in accordance with some embodiments.

FIG. 3B is a partial-cross sectional view diagram of a chip package showing construction of support surfaces for the mirror using a molded part, in accordance with some embodiments.

FIG. 4 is a flow chart of an exemplary manufacturing process for a cap that can be used in a sensor chip package, in accordance with some embodiments.

### DETAILED DESCRIPTION

I. Introduction

The present disclosure relates to a sensor chip package that may be used in a compact instrument for analysis of biological and/or chemical samples. The sensor chip package may house a sensor chip that has multiple sample wells for holding the biological and/or chemical samples. During operation, the sensor chip package may be positioned in the compact instrument such that a light source in the compact instrument can provide excitation light signals to illuminate samples in the sample wells of the sensor chip.

The sensor chip package may comprise a cap that engages the sensor chip and serving as a helmet that covers some or all of a top surface of the sensor chip. The cap remains engaged to the sensor chip while the sensor chip package is positioned in the instrument, and may include multiple features that provide multiple functionalities such as physical protection of parts of the sensor chip from being exposed to the environments, mechanical features to guide and/or secure the sensor chip package into a precise position within the instrument, fluidic ports to provide fluidic communication between sample wells on the sensor chip and external reservoirs, optical components to align excitation light signals from external light sources with desired locations on the sensor chip such as grating couplers on a top surface of the sensor chip, among others.

Aspects of the present disclosure provide a cap design within a sensor chip package that has an optical component to direct an excitation light signal towards the top surface of sensor chip to excite samples within the sample wells. In some embodiments, the optical component may be a mirror or prism that provides a right angle coupling of excitation light signal to the sensor chip. Namely, the optical component can direct an incoming excitation light signal that is substantially parallel to the top surface of the sensor chip, to have a substantially normal incident angle to the top surface of the sensor chip.

The inventors have recognized and appreciated that embodiments of the present disclosure may permit a more compact size for the system that includes the instrument and the sensor chip, which can improve portability and ease of operation of such a system. For example, after a sensor chip package is inserted in the instrument, instead of placing a laser light source directly above the sensor chip to provide illumination with normal incident angles, a right angle coupling allows the laser light source to be placed laterally to one side of the sensor chip, thus providing design flexibility for placement of the laser light source in the instrument. Moreover, providing a deflective optical component as part of the cap in the sensor chip package eliminates the need for a right angle deflector within the instrument directly above the sensor chip, and allows the light source to be positioned closer vertically to the sensor chip package, further reducing the vertical height profile of the system comprising the compact instrument and the sensor chip.

Some embodiments include a mirror placed within a cap body. The mirror has a tilt angle relative to the top surface of the sensor chip to deflect an excitation light signal to a desired incident angle, such that the deflected excitation light signal is received at a desired incident beam location on the sensor chip.

The inventors have recognized and appreciated that during mass manufacturing of sensor chip packages, each cap may not have identical dimensions due in part to variations caused by manufacturing equipment tolerances and errors, among other possible factors. For example, in batch manufacturing where the cap body is constructed using molded parts, each molded cap body may have slightly different dimensions when different molds are used, or when a same mold is used at different environmental conditions. Because the mirror is placed in the cap body of the cap, even minute shifts in the cap body dimension may cause an undesirable amount of change in the mirror tilt angle, causing the deflected excitation light signal to be misaligned with the intended incident beam location.

It may be desirable for the mirror's tilt angle to be adjustable during manufacturing to account for such package-to-package variations and to enable mirror tilt angles in each cap to be individually calibrated. As the cap is usually batch manufactured out of a common mold, it is not economically practical to alter the dimension of each cap body after they are molded for the purpose of adjusting mirror tilt angles. While a movable adjustment mechanism may be added for adjusting a mirror's position, such a mechanism may add to the footprint, complexity and cost of each sensor chip package.

Aspects of the present disclosure are directed to a scalable solution to provide adjustable mirror tilt angles in a cap body during batch manufacturing, without using a movable mechanism. As a result, the complexity and manufacturing cost for the cap may be reduced. The inventors have recognized and appreciated that when two opposing ends of a mirror are supported by different support surfaces in a cap body, the length of the mirror between the two ends may determine the tilt angle of the mirror. In some embodiments, a mirror with a selected length may be inserted into a cap body to provide per package adjustability of tilt angles based on the length of the mirror. The selected length can be calibrated to ensure the desired mirror tilt angle is selected.

Some embodiments are directed to a cap design in which a mirror is supported by multiple support surfaces of the cap body such that a mirror of a different length will provide a different tilt angle when supported by the same support surfaces. In some embodiments, the support surfaces in the cap body include a ramp surface, a second support surface, a third support surface, and a recess in between. At least a portion of the mirror is disposed inside the recess such that one end of the mirror is rested on the second support surface, while the opposing end of the mirror rests on the ramp surface. The ramp surface may be more upright or less. The opposing end of the mirror has a contact point that may be slidable on the ramp surface if the mirror length is changed.

While mirrors are generally described herein as the deflective optical component within the cap, it should be appreciated that embodiments of the present disclosure are not so limited and other optical components that can direct the incident light along a different direction such as by deflection, diffraction or any other optical mechanism may also be used.

The aspects and embodiments described above, as well as additional aspects and embodiments, are described further below. These aspects and/or embodiments may be used individually, all together, or in any combination of two or more, as the disclosure is not limited in this respect.

I. Overview of An Exemplary Sequencing System

Some aspects of the present disclosure relate to a sequencing system for molecular sequencing applications. The packaging and cap described may be used with an exemplary sequencing system, including a chip and instrument, as described below, but the innovation is not so limited as it is envisioned that the packaging and cap may be used with other systems.

A sequencing system may be an instrument that is compact, easy to carry, and easy to operate, allowing a physician or other provider to readily use the instrument and transport the instrument to a desired location where care may be needed. Analysis of a sample may include labeling the sample with one or more fluorescent markers, which may be used to detect the sample and/or identify single molecules of the sample (e.g., individual nucleotide identification as part of nucleic acid sequencing or). A fluorescent marker may become excited in response to illuminating the fluorescent marker with excitation light (e.g., light having a characteristic wavelength that may excite the fluorescent marker to an excited state) and, if the fluorescent marker becomes excited, emit emission light (e.g., light having a characteristic wavelength emitted by the fluorescent marker by returning to a ground state from an excited state). Detection of the emission light may allow for identification of the fluorescent marker, and thus, the sample or a molecule of the sample labeled by the fluorescent marker. According to some embodiments, the instrument may be capable of massively-parallel sample analyses and may be configured to handle tens of thousands of samples or more simultaneously.

The sequencing system may be a compact system that is capable of analyzing biological or chemical samples in parallel, including identification of single molecules and nucleic acid sequencing. The system may include an integrated device and an instrument configured to interface with the integrated device. The instrument may include one or more excitation light sources, and the integrated device may interface with the instrument such that the excitation light is delivered to the sample wells using integrated optical components (e.g., waveguides, optical couplers, optical splitters) formed as part of the integrated device. The integrated device may include an array of pixels, where each pixel includes a sample well and at least one photodetector. A surface of the integrated device may have a plurality of sample wells, where a sample well is configured to receive a sample from a sample placed on the surface of the integrated device. A sample may contain multiple samples, and in some embodiments, different types of samples. The plurality of sample wells may have a suitable size and shape such that at least a portion of the sample wells receive one sample from a sample. In some embodiments, the number of samples within a sample well may be distributed among the sample wells such that some sample wells contain one sample with others contain zero, two or more samples.

In some embodiments, a sample may be a biological and/or chemical sample for nucleic acid (e.g. DNA, RNA) sequencing or protein sequencing (e.g. determining amino acid sequence information in polypeptides). For example, a sample may contain multiple single-stranded DNA templates, and individual sample wells on a surface of an integrated device may be sized and shaped to receive a sequencing template. Sequencing templates may be distributed among the sample wells of the integrated device such that at least a portion of the sample wells of the integrated device contain a sequencing template. The sample may also contain labeled nucleotides which then enter in the sample well and may allow for identification of a nucleotide as it is incorporated into a strand of DNA complementary to the single-stranded DNA template in the sample well. In such an example, the “sample” may refer to both the sequencing template and the labeled nucleotides currently being incorporated by a polymerase. In some embodiments, the sample may contain sequencing templates and labeled nucleotides may be subsequently introduced to a sample well as nucleotides are incorporated into a complementary strand within the sample well. In this manner, timing of incorporation of nucleotides may be controlled by when labeled nucleotides are introduced to the sample wells of an integrated device. Examples of nucleic acid sequencing and protein sequencing applications are described in U.S. Pat. No. 11,001,875, issued May 11, 2021, titled “METHODS FOR NUCLEIC ACID SEQUENCING,” and U.S. patent application Ser. No. 17/326,247, filed May 20, 2021, titled “METHODS AND COMPOSITIONS FOR PROTEIN SEQUENCING,” each of which is incorporated by reference in its entirety.

Excitation light is provided from an excitation source located separate from the pixel array of the integrated device. The excitation light is directed at least in part by elements of the integrated device towards one or more pixels to illuminate an illumination region within the reaction chamber. A marker may then emit emission light when located within the illumination region and in response to being illuminated by excitation light. In some embodiments, one or more excitation sources are part of the instrument of the system where components of the instrument and the integrated device are configured to direct the excitation light towards one or more pixels.

Emission light emitted from a reaction chamber (e.g., by a fluorescent label) may then be detected by one or more photodetectors within a pixel of the integrated device. Characteristics of the detected emission light may provide an indication for identifying the marker associated with the emission light. Such characteristics may include any suitable type of characteristic, including an arrival time of photons detected by a photodetector, an amount of photons accumulated over time by a photodetector, and/or a distribution of photons across two or more photodetectors. In some embodiments, a photodetector may have a configuration that allows for the detection of one or more timing characteristics associated with emission light (e.g., fluorescence lifetime). The photodetector may detect a distribution of photon arrival times after a pulse of excitation light propagates through the integrated device, and the distribution of arrival times may provide an indication of a timing characteristic of the emission light (e.g., a proxy for fluorescence lifetime). In some embodiments, the one or more photodetectors provide an indication of the probability of emission light emitted by the marker (e.g., fluorescence intensity). In some embodiments, a plurality of photodetectors may be sized and arranged to capture a spatial distribution of the emission light. Output signals from the one or more photodetectors may then be used to distinguish a marker from among a plurality of markers, where the plurality of markers may be used to identify a sample or its structure. In some embodiments, a sample may be excited by multiple excitation energies, and emission light and/or timing characteristics of the emission light from the reaction chamber in response to the multiple excitation energies may distinguish a marker from a plurality of markers.

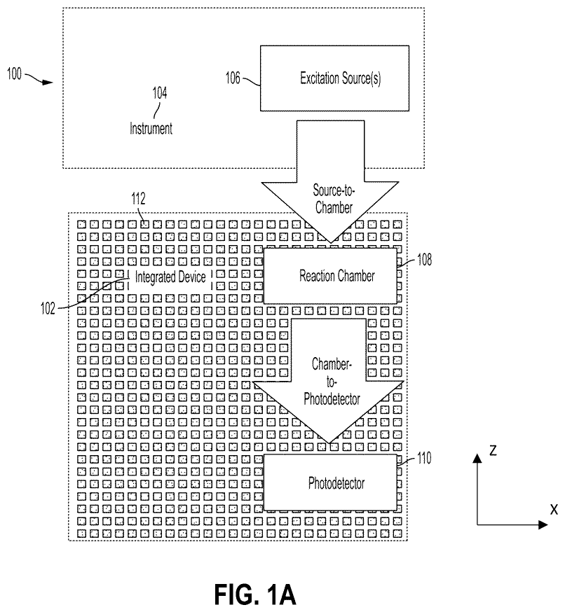

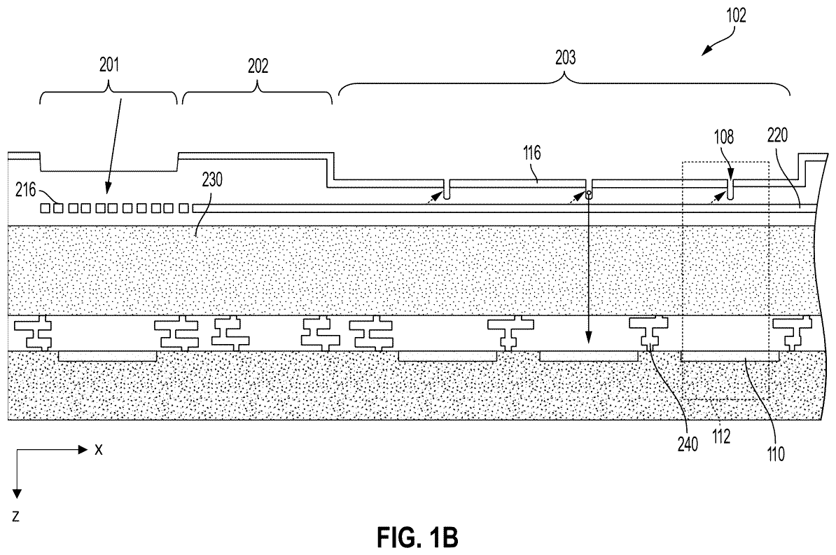

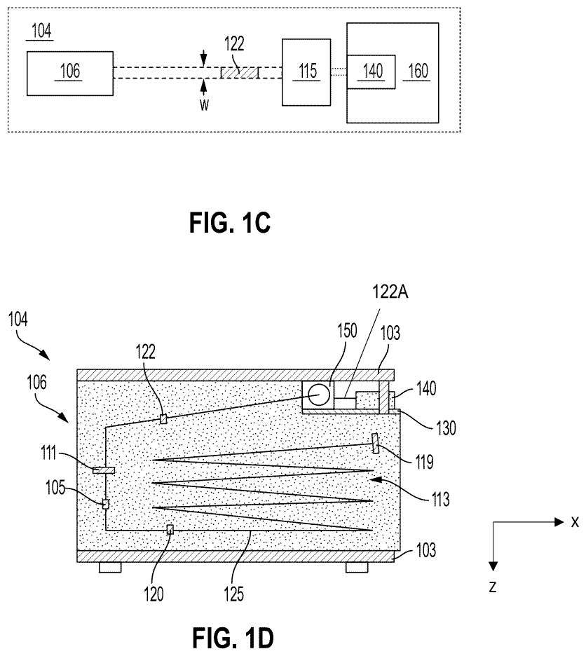

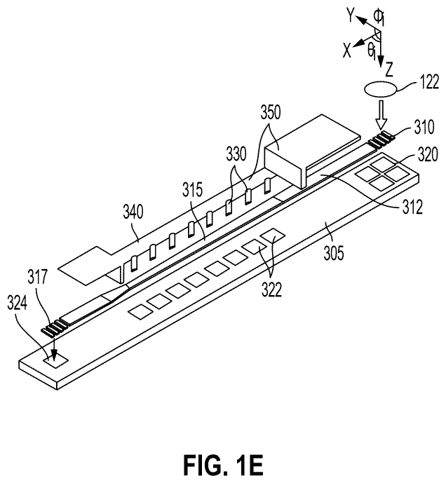

A schematic overview of a sequencing system 100 is illustrated in FIG. 1A. The system 100 comprises both an integrated device 102 that interfaces with an instrument 104. In some embodiments, instrument 104 may include one or more excitation sources 106 integrated as part of instrument 104. In some embodiments, an excitation source may be external to both instrument 104 and integrated device 102, and instrument 104 may be configured to receive excitation light from the excitation source and direct excitation light to the integrated device. The integrated device may interface with the instrument using any suitable socket for receiving the integrated device and holding it in precise optical alignment with the excitation source. The excitation source 106 may be configured to provide excitation light to the integrated device 102, which is sometimes also referred to as a chip or sensor chip. As illustrated schematically in FIG. 1A, the integrated device 102 has a plurality of pixels 112, where at least a portion of pixels may perform independent analysis of a sample of interest. Such pixels 112 may be referred to as “passive source pixels” since a pixel receives excitation light from a source 106 separate from the pixel, where excitation light from the source excites some or all of the pixels 112. Excitation source 106 may be any suitable light source. Examples of suitable excitation sources are described in U.S. patent application Ser. No. 14/821,688, filed Aug. 7, 2015, titled “INTEGRATED DEVICE FOR PROBING, DETECTING AND ANALYZING MOLECULES,” which is incorporated by reference in its entirety. In some embodiments, excitation source 106 includes multiple excitation sources that are combined to deliver excitation light to integrated device 102. The multiple excitation sources may be configured to produce multiple excitation energies or wavelengths.

A pixel 112 has a reaction chamber 108 (also referred to as “sample well”) configured to receive a single sample of interest and a photodetector 110 for detecting emission light emitted from the reaction chamber in response to illuminating the sample and at least a portion of the reaction chamber 108 with excitation light provided by the excitation source 106. In some embodiments, reaction chamber 108 may retain the sample in proximity to a surface of integrated device 102, which may ease delivery of excitation light to the sample and detection of emission light from the sample or a reaction component (e.g., a labeled nucleotide).

Optical elements for coupling excitation light from excitation light source 106 to integrated device 102 and guiding excitation light to the reaction chamber 108 are located both on integrated device 102 and the instrument 104. Source-to-chamber optical elements may comprise one or more grating couplers located on integrated device 102 to couple excitation light to the integrated device and waveguides to deliver excitation light from instrument 104 to reaction chambers in pixels 112. One or more optical splitter elements may be positioned between a grating coupler and the waveguides. The optical splitter may couple excitation light from the grating coupler and deliver excitation light to at least one of the waveguides. In some embodiments, the optical splitter may have a configuration that allows for delivery of excitation light to be substantially uniform across all the waveguides such that each of the waveguides receives a substantially similar amount of excitation light. Such embodiments may improve performance of the integrated device by improving the uniformity of excitation light received by reaction chambers of the integrated device.

Reaction chamber 108, a portion of the excitation source-to-chamber optics, and the reaction chamber-to-photodetector optics are located on integrated device 102. Excitation source 106 and a portion of the source-to-chamber components are located in instrument 104. In some embodiments, a single component may play a role in both coupling excitation light to reaction chamber 108 and delivering emission light from reaction chamber 108 to photodetector 110. Examples of suitable components, for coupling excitation light to a reaction chamber and/or directing emission light to a photodetector, to include in an integrated device are described in U.S. patent application Ser. No. 14/821,688, filed Aug. 7, 2015, titled “INTEGRATED DEVICE FOR PROBING, DETECTING AND ANALYZING MOLECULES,” and U.S. patent application Ser. No. 14/543,865, filed Nov. 17, 2014, titled “INTEGRATED DEVICE WITH EXTERNAL LIGHT SOURCE FOR PROBING, DETECTING, AND ANALYZING MOLECULES,” both of which are incorporated by reference in their entirety.

Pixel 112 is associated with its own individual reaction chamber 108 and at least one photodetector 110. The plurality of pixels of integrated device 102 may be arranged to have any suitable shape, size, and/or dimensions. Integrated device 102 may have any suitable number of pixels. The number of pixels in integrated device 102 may be in the range of approximately 10,000 pixels to 1,000,000 pixels or any value or range of values within that range. In some embodiments, the pixels may be arranged in an array of 512 pixels by 512 pixels. Integrated device 102 may interface with instrument 104 in any suitable manner. In some embodiments, instrument 104 may have an interface that detachably couples to integrated device 102 such that a user may attach integrated device 102 to instrument 104 for use of integrated device 102 to analyze at least one sample of interest in a suspension and remove integrated device 102 from instrument 104 to allow for another integrated device to be attached. The interface of instrument 104 may position integrated device 102 to couple with circuitry of instrument 104 to allow for readout signals from one or more photodetectors to be transmitted to instrument 104. Integrated device 102 and instrument 104 may include multi-channel, high-speed communication links for handling data associated with large pixel arrays (e.g., more than 10,000 pixels).

A cross-sectional schematic of an exemplary integrated device 102 illustrating a row of pixels 112 is shown in FIG. 1B. Integrated device 102 may include coupling region 201, routing region 202, and pixel region 203. Pixel region 203 may include a plurality of pixels 112 having reaction chambers 108 positioned on a surface at a location separate from coupling region 201, which is where excitation light (shown as the dashed arrow) couples to integrated device 102. Reaction chambers 108 may be formed through metal layer(s) 116. One pixel 112, illustrated by the dotted rectangle, is a region of integrated device 102 that includes a reaction chamber 108 and a photodetection region having one or more photodetectors 110.

FIG. 1B illustrates the path of excitation (shown in dashed lines) by coupling a beam of excitation light to coupling region 201 and to reaction chambers 108. The row of reaction chambers 108 shown in FIG. 1B may be positioned to optically couple with waveguide 220. Excitation light may illuminate a sample located within a reaction chamber. The sample or a reaction component (e.g., fluorescent label) may reach an excited state in response to being illuminated by the excitation light. When in an excited state, the sample or reaction component may emit emission light, which may be detected by one or more photodetectors associated with the reaction chamber. FIG. 1B schematically illustrates the path of emission light (shown as the solid line) from a reaction chamber 108 to photodetector(s) 110 of pixel 112. The photodetector(s) 110 of pixel 112 may be configured and positioned to detect emission light from reaction chamber 108. Examples of suitable photodetectors are described in U.S. patent application Ser. No. 14/821,656, filed Aug. 7, 2015, titled “INTEGRATED DEVICE FOR TEMPORAL BINNING OF RECEIVED PHOTONS,” which is incorporated by reference in its entirety. For an individual pixel 112, a reaction chamber 108 and its respective photodetector(s) 110 may be aligned along a common axis (along the direction denoted as Z direction as shown in FIG. 1B). In this manner, the photodetector(s) may overlap with the reaction chamber within a pixel 112.

The directionality of the emission light from a reaction chamber 108 may depend on the positioning of the sample in the reaction chamber 108 relative to metal layer(s) 116 because metal layer(s) 116 may act to reflect emission light. In this manner, a distance between metal layer(s) 116 and a fluorescent marker positioned in a reaction chamber 108 may impact the efficiency of photodetector(s) 110, that are in the same pixel as the reaction chamber, to detect the light emitted by the fluorescent marker. The distance between metal layer(s) 116 and the bottom surface of a reaction chamber 106, which is proximate to where a sample may be positioned during operation, may be in the range of 100 nm to 500 nm, or any value or range of values in that range. In some embodiments the distance between metal layer(s) 116 and the bottom surface of a reaction chamber 108 is approximately 300 nm.

The distance between the sample and the photodetector(s) may also impact efficiency in detecting emission light. By decreasing the distance light has to travel between the sample and the photodetector(s), detection efficiency of emission light may be improved. In addition, smaller distances between the sample and the photodetector(s) may allow for pixels that occupy a smaller area footprint of the integrated device, which can allow for a higher number of pixels to be included in the integrated device. The distance between the bottom surface of a reaction chamber 108 and photodetector(s) may be in the range of 1 μm to 15 μm, or any value or range of values in that range.

Photonic structure(s) 230 may be positioned between reaction chambers 108 and photodetectors 110 and configured to reduce or prevent excitation light from reaching photodetectors 110, which may otherwise contribute to signal noise in detecting emission light. As shown in FIG. 1B, the one or more photonic structures 230 may be positioned between waveguide 220 and photodetectors 110. Photonic structure(s) 230 may include one or more optical rejection photonic structures including a spectral filter, a polarization filter, and a spatial filter. Photonic structure(s) 230 may be positioned to align with individual reaction chambers 108 and their respective photodetector(s) 110 along a common axis. Metal layers 240, which may act as a circuitry for integrated device 102, may also act as a spatial filter, in accordance with some embodiments. In such embodiments, one or more metal layers 240 may be positioned to block some or all excitation light from reaching photodetector(s) 110.

Coupling region 201 may include one or more optical components configured to couple excitation light from an external excitation source. Coupling region 201 may include grating coupler 216 positioned to receive some or all of a beam of excitation light. Examples of suitable grating couplers are described in U.S. patent application Ser. No. 15/844,403, filed Dec. 15, 2017, titled “OPTICAL COUPLER AND WAVEGUIDE SYSTEM,” which is incorporated by reference in its entirety. Grating coupler 216 may couple excitation light to waveguide 220, which may be configured to propagate excitation light to the proximity of one or more reaction chambers 108. Alternatively, coupling region 201 may comprise other well-known structures for coupling light into a waveguide.

Components located off of the integrated device may be used to position and align the excitation source 106 to the integrated device. Such components may include optical components including lenses, mirrors, prisms, windows, apertures, attenuators, and/or optical fibers. Additional mechanical components may be included in the instrument to allow for control of one or more alignment components. Such mechanical components may include actuators, stepper motors, and/or knobs. Examples of suitable excitation sources and alignment mechanisms are described in U.S. patent application Ser. No. 15/161,088, filed May 20, 2016, titled “PULSED LASER AND SYSTEM,” which is incorporated by reference in its entirety. Another example of a beam-steering module is described in U.S. patent application Ser. No. 15/842,720, filed Dec. 14, 2017, titled “COMPACT BEAM SHAPING AND STEERING ASSEMBLY,” which is incorporated herein by reference.

A sample to be analyzed may be introduced into reaction chamber 108 of pixel 112. The sample may be a biological sample or any other suitable sample, such as a chemical sample. In some cases, the suspension may include multiple molecules of interest and the reaction chamber may be configured to isolate a single molecule. In some instances, the dimensions of the reaction chamber may act to confine a single molecule within the reaction chamber, allowing measurements to be performed on the single molecule. Excitation light may be delivered into the reaction chamber 108, so as to excite the sample or at least one fluorescent marker attached to the sample or otherwise associated with the sample while it is within an illumination area within the reaction chamber 108.

In operation, parallel analyses of samples within the reaction chambers are carried out by exciting some or all of the samples within the reaction chambers using excitation light and detecting signals with the photodetectors that are representative of emission light from the reaction chambers. Emission light from a sample or reaction component (e.g., fluorescent label) may be detected by a corresponding photodetector and converted to at least one electrical signal. The electrical signals may be transmitted along conducting lines (e.g., metal layers 240) in the circuitry of the integrated device, which may be connected to an instrument interfaced with the integrated device. The electrical signals may be subsequently processed and/or analyzed. Processing or analyzing of electrical signals may occur on a suitable computing device either located on or off the instrument.

Referring back to FIG. 1A, instrument 104 may include a user interface for controlling operation of instrument 104 and/or integrated device 102. The user interface may be configured to allow a user to input information into the instrument, such as commands and/or settings used to control the functioning of the instrument. In some embodiments, the user interface may include buttons, switches, dials, and a microphone for voice commands. The user interface may allow a user to receive feedback on the performance of the instrument and/or integrated device, such as proper alignment and/or information obtained by readout signals from the photodetectors on the integrated device. In some embodiments, the user interface may provide feedback using a speaker to provide audible feedback. In some embodiments, the user interface may include indicator lights and/or a display screen for providing visual feedback to a user.

In some embodiments, instrument 104 may include a computer interface configured to connect with a computing device. Computer interface may be a USB interface, a FireWire interface, or any other suitable computer interface. Computing device may be any general purpose computer, such as a laptop or desktop computer. In some embodiments, computing device may be a server (e.g., cloud-based server) accessible over a wireless network via a suitable computer interface. The computer interface may facilitate communication of information between instrument 104 and the computing device. Input information for controlling and/or configuring the instrument 104 may be provided to the computing device and transmitted to instrument 104 via the computer interface. Output information generated by instrument 104 may be received by the computing device via the computer interface. Output information may include feedback about performance of instrument 104, performance of integrated device 112, and/or data generated from the readout signals of photodetector 110.

In some embodiments, instrument 104 may include a processing device configured to analyze data received from one or more photodetectors of integrated device 102 and/or transmit control signals to excitation source(s) 2-106. In some embodiments, the processing device may comprise a general purpose processor, a specially-adapted processor (e.g., a central processing unit (CPU) such as one or more microprocessor or microcontroller cores, a field-programmable gate array (FPGA), an application-specific integrated circuit (ASIC), a custom integrated circuit, a digital signal processor (DSP), or a combination thereof.) In some embodiments, the processing of data from one or more photodetectors may be performed by both a processing device of instrument 104 and an external computing device. In other embodiments, an external computing device may be omitted and processing of data from one or more photodetectors may be performed solely by a processing device of integrated device 102.

Referring to FIG. 1C, an exemplary portable, advanced analytic instrument 104 can comprise one or more pulsed optical sources 106 mounted as a replaceable module within, or otherwise coupled to, the instrument 104. The portable analytic instrument 104 can include an optical coupling system 115 and an analytic system 160. The optical coupling system 115 can include some combination of optical components (which may include, for example, none, one from among, or more than one component from among the following components: lens, mirror, optical filter, attenuator, beam-steering component, beam shaping component) and be configured to operate on and/or couple output optical pulses 122 from the pulsed optical source 106 to the analytic system 160. The analytic system 160 can include a plurality of components that are arranged to direct the optical pulses to at least one reaction chamber for sample analysis, receive one or more optical signals (e.g., fluorescence, backscattered radiation) from the at least one reaction chamber, and produce one or more electrical signals representative of the received optical signals. In some embodiments, the analytic system 160 can include one or more photodetectors and may also include signal-processing electronics (e.g., one or more microcontrollers, one or more field-programmable gate arrays, one or more microprocessors, one or more digital signal processors, logic gates, etc.) configured to process the electrical signals from the photodetectors. The analytic system 160 can also include data transmission hardware configured to transmit and receive data to and from external devices (e.g., one or more external devices on a network to which the instrument 104 can connect via one or more data communications links). In some embodiments, the analytic system 160 can be configured to receive a bio-optoelectronic chip 140, which holds one or more samples to be analyzed.

FIG. 1D depicts a further detailed example of a portable analytical instrument 104 that includes a compact pulsed optical source 108. In this example, the pulsed optical source 108 comprises a compact, passively mode-locked laser module 113. A passively mode-locked laser can produce optical pulses autonomously, without the application of an external pulsed signal. In some implementations, the module can be mounted to an instrument chassis or frame 103, and may be located inside an outer casing of the instrument. According to some embodiments, a pulsed optical source 106 can include additional components that can be used to operate the optical source and operate on an output beam from the optical source 106. A mode-locked laser 113 may comprise an element (e.g., saturable absorber, acousto-optic modulator, Kerr lens) in a laser cavity, or coupled to the laser cavity, that induces phase locking of the laser's longitudinal frequency modes. The laser cavity can be defined in part by cavity end mirrors 111, 119. Such locking of the frequency modes results in pulsed operation of the laser (e.g., an intracavity pulse 120 bounces back-and-forth between the cavity end mirrors) and produces a stream of output optical pulses 122 from one end mirror 111 which is partially transmitting.

In some cases, the analytic instrument 104 is configured to receive a removable, packaged, bio-optoelectronic chip or optoelectronic chip 140 (also referred to as a “disposable chip” or “sensor chip”). The disposable chip can include a bio-optoelectronic chip, for example, that comprises a plurality of reaction chambers, integrated optical components arranged to deliver optical excitation energy to the reaction chambers, and integrated photodetectors arranged to detect fluorescent emission from the reaction chambers. In some implementations, the chip 140 can be disposable after a single use, whereas in other implementations the chip 140 can be reused two or more times. When the chip 140 is received by the instrument 104, it can be in electrical and optical communication with the pulsed optical source 106 and with apparatus in the analytic system 160. Electrical communication may be made through electrical contacts on the chip package, for example.

In some embodiments and referring to FIG. 1D, the disposable chip 140 can be mounted (e.g., via a socket connection) on an electronic circuit board 130, such as a printed circuit board (PCB) that can include additional instrument electronics. The PCB 130 has a surface that is generally parallel to the X-Y plane. The PCB 130 can include circuitry configured to provide electrical power, one or more clock signals, and control signals to the optoelectronic chip 140, and signal-processing circuitry arranged to receive signals representative of fluorescent emission detected from the reaction chambers. Data returned from the optoelectronic chip can be processed in part or entirely by electronics on the instrument 104, although data may be transmitted via a network connection to one or more remote data processors, in some implementations. The PCB 130 can also include circuitry configured to receive feedback signals from the chip relating to optical coupling and power levels of the optical pulses 122 coupled into waveguides of the optoelectronic chip 140. The feedback signals can be provided to one or both of the pulsed optical source 106 and optical system 115 to control one or more parameters of the output beam of optical pulses 122. In some cases, the PCB 130 can provide or route power to the pulsed optical source 106 for operating the optical source and related circuitry in the optical source 106.

According to some embodiments, the pulsed optical source 106 comprises a compact mode-locked laser module 113. The mode-locked laser can comprise a gain medium 105 (which can be solid-state material in some embodiments), an output coupler 111, and a laser-cavity end mirror 119. The mode-locked laser's optical cavity can be bound by the output coupler 111 and end mirror 119. An optical axis 125 of the laser cavity can have one or more folds (turns) to increase the length of the laser cavity and provide a desired pulse repetition rate. The pulse repetition rate is determined by the length of the laser cavity (e.g., the time for an optical pulse to make a round-trip within the laser cavity).

In some embodiments, there can be additional optical elements (not shown in FIG. 1D) in the laser cavity for beam shaping, wavelength selection, and/or pulse forming. In some cases, the end mirror 119 comprises a saturable-absorber mirror (SAM) that induces passive mode locking of longitudinal cavity modes and results in pulsed operation of the mode-locked laser. The mode-locked laser module 113 can further include a pump source (e.g., a laser diode, not shown in FIG. 1D) for exciting the gain medium 105. Further details of a mode-locked laser module 113 can be found in U.S. patent application Ser. No. 15/844,469, titled “COMPACT MODE-LOCKED LASER MODULE,” filed Dec. 15, 2017, the entirety of which is incorporated herein by reference.

According to some implementations, a beam-steering module 150 can receive output pulses from the pulsed optical source 106 and is configured to adjust at least the position and incident angles of the optical pulses onto an optical coupler (e.g., grating coupler) of the optoelectronic chip 140. In some cases, the output pulses 122 from the pulsed optical source 106 can be operated on by a beam-steering module 150 to additionally or alternatively change a beam shape and/or beam rotation at an optical coupler on the optoelectronic chip 140. In some implementations, the beam-steering module 150 can further provide focusing and/or polarization adjustments of the beam of output pulses onto the optical coupler. One example of a beam-steering module is described in U.S. patent application Ser. No. 15/161,088 titled “Pulsed Laser and Bioanalytic System,” filed May 20, 2016, which is incorporated herein by reference. Another example of a beam-steering module is described in a separate U.S. patent application No. 62/435,679, filed Dec. 16, 2016 and titled “Compact Beam Shaping and Steering Assembly,” which is incorporated herein by reference.

Notably, in the example shown in FIG. 1D, an excitation light signal 122A after beam-steering module 150 is provided along the direction denoted as X direction and substantially parallel to the X-Y plane.

Referring to FIG. 1E, the output pulses 122 from the excitation light signal 122A can be coupled into one or more optical waveguides 312 on a bio-optoelectronic chip 140. In the example shown, a right angle coupling is used to change the propagation direction of the excitation light signal 122A from along the X direction to along the Z direction towards the optical waveguides 312. Any suitable optical component may be used to facilitate the right angle coupling of the output pulses 122. In some embodiments, a cap having a deflective optical component such as a mirror may be used, which is described in more detail in the next section. In some embodiments, the optical pulses can be coupled to one or more waveguides via a grating coupler 310, though coupling to an end of one or more optical waveguides on the optoelectronic chip can be used in some embodiments. According to some embodiments, a quad detector 320 can be located on a semiconductor substrate 305 (e.g., a silicon substrate) for aiding in alignment of the beam of optical pulses 122 to a grating coupler 310. The one or more waveguides 312 and reaction chambers or reaction chambers 330 can be integrated on the same semiconductor substrate with intervening dielectric layers (e.g., silicon dioxide layers) between the substrate, waveguide, reaction chambers, and photodetectors 322.

Each waveguide 312 can include a tapered portion 315 below the reaction chambers 330 to equalize optical power coupled to the reaction chambers along the waveguide. The reducing taper can force more optical energy outside the waveguide's core, increasing coupling to the reaction chambers and compensating for optical losses along the waveguide, including losses for light coupling into the reaction chambers. A second grating coupler 317 can be located at an end of each waveguide to direct optical energy to an integrated photodiode 324. The integrated photodiode can detect an amount of power coupled down a waveguide and provide a detected signal to feedback circuitry that controls the beam-steering module 150, for example.

The reaction chambers 330 or reaction chambers 330 can be aligned with the tapered portion 315 of the waveguide and recessed in a tub 340. There can be photodetectors 322 located on the semiconductor substrate 305 for each reaction chamber 330. In some embodiments, a semiconductor absorber (shown in FIG. 5 as an optical filter 530) may be located between the waveguide and a photodetector 322 at each pixel. A metal coating and/or multilayer coating 350 can be formed around the reaction chambers and above the waveguide to prevent optical excitation of fluorophores that are not in the reaction chambers (e.g., dispersed in a solution above the reaction chambers). The metal coating and/or multilayer coating 350 may be raised beyond edges of the tub 340 to reduce absorptive losses of the optical energy in the waveguide 312 at the input and output ends of each waveguide.

There can be a plurality of rows of waveguides, reaction chambers, and time-binning photodetectors on the optoelectronic chip 140. For example, there can be 128 rows, each having 512 reaction chambers, for a total of 65,536 reaction chambers in some implementations. Other implementations may include fewer or more reaction chambers, and may include other layout configurations. Optical power from the pulsed optical source 106 can be distributed to the multiple waveguides via one or more star couplers or multi-mode interference couplers, or by any other means, located between an optical coupler 310 to the chip 140 and the plurality of waveguides 312.

II. Overview of An Exemplary Cap Design

Some aspects relate to a chip package that includes a cap disposed on an integrated device/sensor chip that comprises an optical component such as a mirror for alignment of the excitation source 106 with the integrated device.

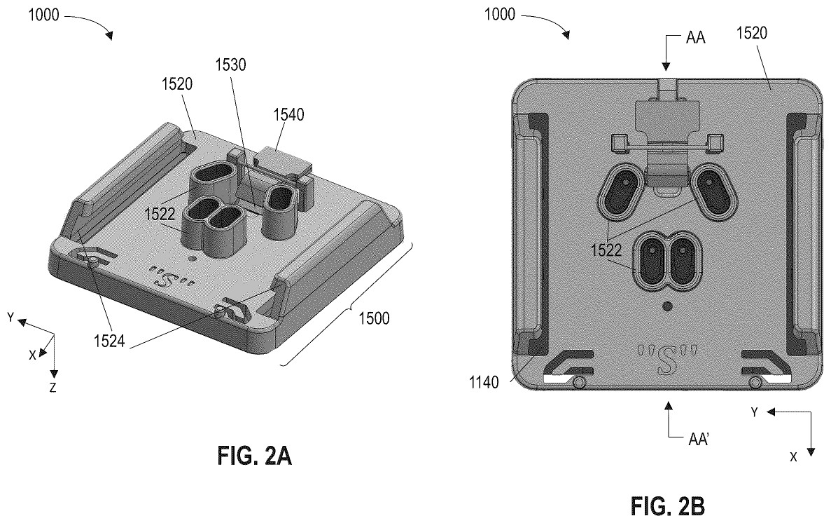

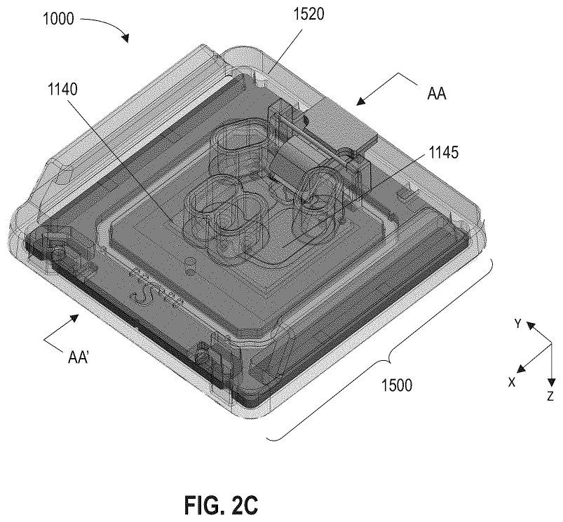

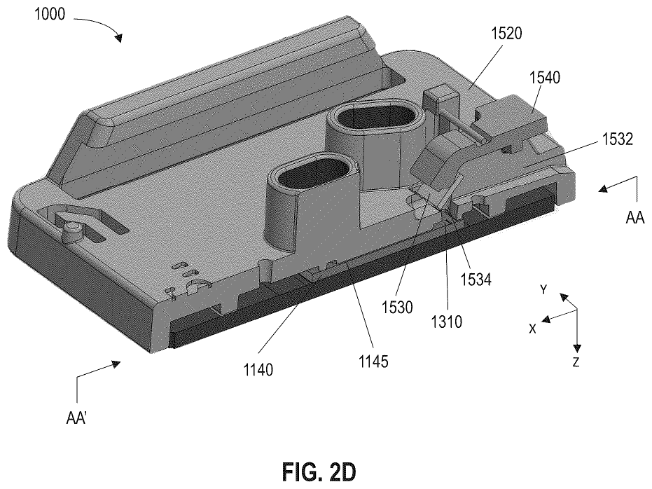

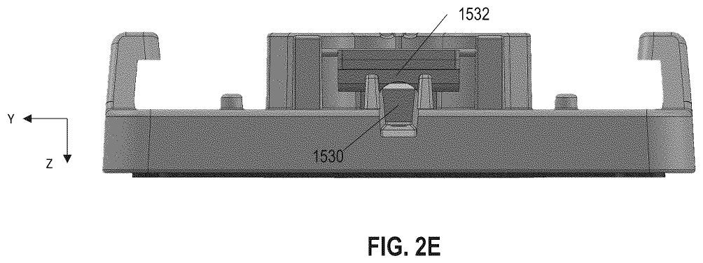

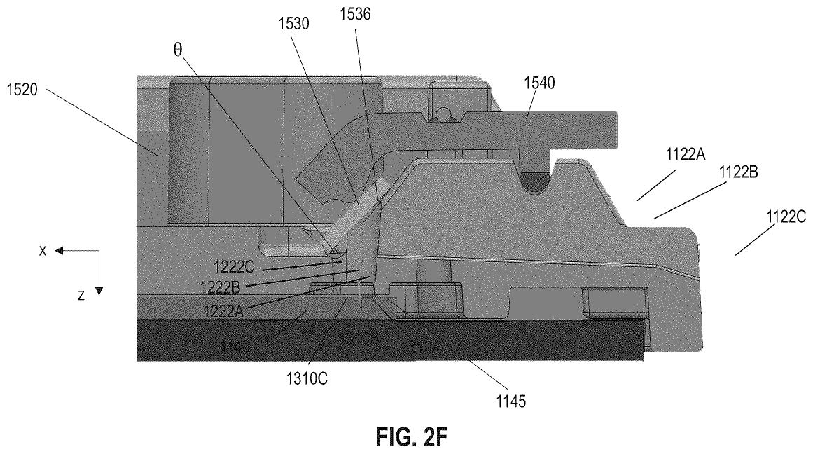

An exemplary cap design in a chip package according to embodiments of the present disclosure will now be described with reference to FIGS. 2A-2D. FIG. 2A is a perspective view schematic diagram of an exemplary chip package 1000, in accordance with some embodiments. FIG. 2B is a top-view schematic diagram of the exemplary chip package shown in FIG. 2A. FIG. 2C is a perspective-view schematic diagram of the chip package shown in FIG. 2A, with the cap being made partially transparent to illustrate the relationship between the cap and the sensor chip within the chip package.

As shown, chip package 1000 is an assembly that includes chip 1140 and a cap 1500. Chip 1140 may be a sensor chip similar to the optoelectronic chip 140 as shown in FIGS. 1D, lE and described above. As shown in FIG. 2A, cap 1500 is disposed on top of chip 1140 along a vertical direction denoted as Z direction. As shown in FIG. 2C, chip 1140 has a top surface 1145 generally along the X-Y plane. Cap 1500 acts as a helmet or helmet assembly that covers a majority of top surface 1145 to provide physical protection to prevent the covered portion of top surface 1145 from being exposed to the environments, among other purposes. Some portions of top surface 1145 are not covered by the cap to permit external access to fluidic, optical signals etc. by the sensor chip.

Referring back to FIG. 2A, cap 1500 is itself an assembly that includes a cap body 1520, a mirror 1530 and a clip 1540. Cap body 1520 may be formed of any suitable material that can be batch manufactured in a cost-effective fashion. Preferably, cap body 1520 is a molded part that is formed by molding a polymer material. The molding can be insert molding, while other molding or non-molding process for shaping a polymer material may also be used such as 3D printing of a polymer material. The polymer material for the cap body may be any suitable plastic material, as aspects of the present disclosure are not so limited.

Chip package 1000 may be a disposable, removable package that is received in instrument 104. As shown in FIG. 2A, cap body 1520 includes mechanical guides 1524 that are configured to guide insertion of the chip package 1000 into corresponding slots or detents in an instrument such as instrument 104. Guides 1524 may also include stops or latches to secure chip package 1000 into a precise predefined location relative to a light source within instrument 104 when chip package 1000 is fully inserted. Cap body 1520 may also include fluidic ports 1522 to provide fluidic communication between sample wells on the sensor chip 1140 and external reservoirs (not shown). It should be appreciated that while FIG. 2A shows an example in which fluidic ports 1522 and guides 1524 are part of cap body 1520, aspects of the present disclosure are not so limited. In some embodiments, a fluidic port and/or a guide may be formed of a separate structure from the cap body.

FIG. 2D is a cutaway perspective view diagram of the chip package of FIG. 2B illustrating the relationship between the mirror and the sensor chip. FIG. 2D is cut along lines AA-AA′ shown in FIG. 2B and FIG. 2C, and shows mirror 1530 positioned between a retaining clip 1540 and cap body 1520 with a tilt angle to deflect an incoming light signal along X direction downward along substantially the Z direction towards grating coupler 1310 located on the top surface 1145. An incoming excitation light signal may be received along channel 1532 that extends substantially parallel to the top surface 1145, and the deflected light signal may pass through an opening 1534 of cap body 1520 to be incident on the top surface 1145. The mirror 1530 and channel 1532 are also illustrated in FIG. 2E, which is a side view diagram along the X direction of the chip package of FIG. 2B.

FIG. 2F is a partial-cross sectional view diagram of the chip package of FIG. 2B, with annotations illustrating the right angle coupling of incoming excitation light signal using a mirror in the cap. In FIG. 2F, incoming excitation light signal 1122A may comprise output laser pulses from an external light source such as light source 106 within instrument 104 (not shown in FIG. 2F). Excitation light signal 1122A propagates substantially along the X direction from the right to the left in FIG. 2F, and is deflected by a reflective surface 1536 of the mirror 1530 towards top surface 1145 of the sensor chip as a deflected light signal 1222A. Deflected light signal 1222A propagates substantially along the Z direction, and is received at a spot 1310A on the sensor chip 1140. Mirror 1530 therefore serves as right angle couplers between light signal 1122A and deflected light signal 1222A.

Still referring to FIG. 2F, which also shows right angle coupling between a second excitation light signal 1122B and a deflected light signal 1222B that is received at spot 1310B, and between a third excitation light signal 1122C and a deflected light signal 1222C that is received at spot 1310C. Spots 1310A, 1310B and 1310C may be aligned with one or more coupling regions on sensor chip 1140, such as coupling region 201 as discussed above. In some embodiments, spots 1310A, 1310B and 1310C may be aligned with grating couplers such as grating couplers 216 within the coupling regions that are each configured to optically couple the respective deflected excitation light signal to at least one waveguide on the sensor chip for exciting samples within sample wells of the sensor chip.

It should be appreciated that while a mirror 1530 is shown, it is only an example and other optically reflective structures such as a prism may also be used to deflect incoming excitation light signals towards the top surface of the sensor chip.

III. Adjustable Mirror Tilt Angle Based on Mirror Length

In the example shown in FIG. 2F, mirror 1530 is tilted around an axis parallel to Y direction, at a tilt angle θ relative to the X-Y plane (or the top surface 1145 of the sensor chip). Some aspects are directed to a cap body design having multiple support surfaces for the mirror to rest on such that the mirror tilt angle θ may be a function of a mirror length.

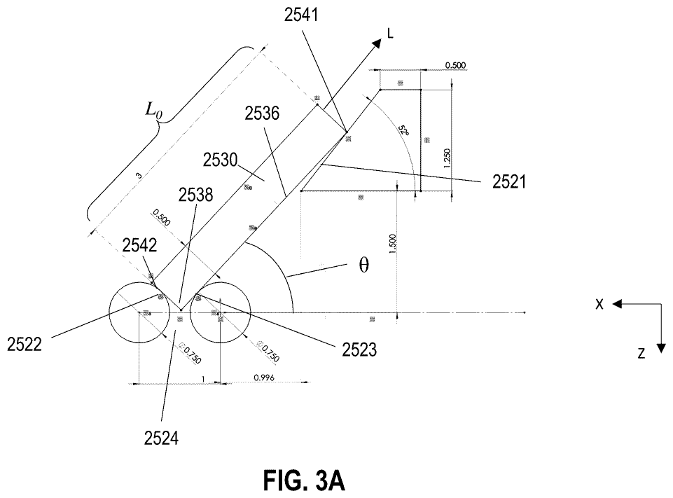

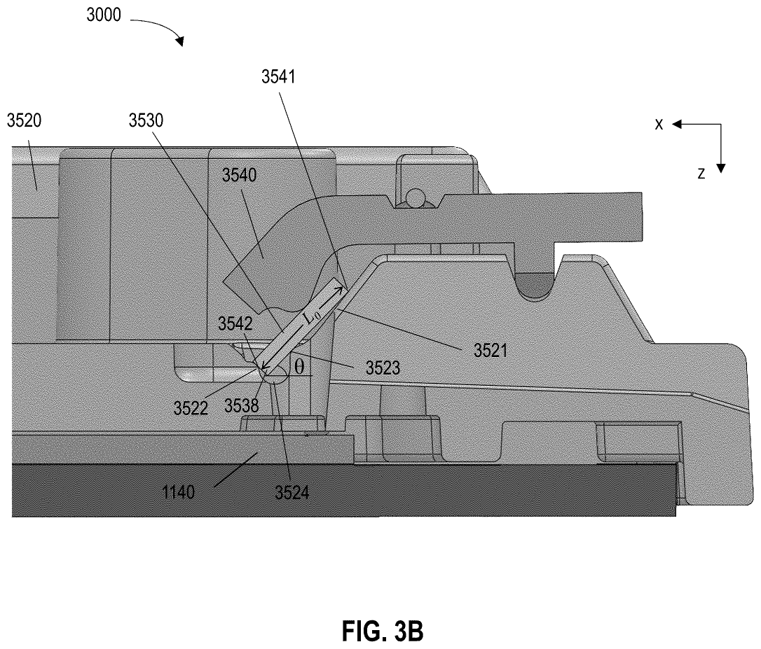

FIG. 3A is a high level side view diagram of a mirror supported by multiple support surfaces in a cap body, in accordance with some embodiments. In FIG. 3A, mirror 2530 is similar to mirror 1530 of FIGS. 2A-2F in many aspects, and has a generally rectangular shape in the X-Z plane, and a length L₀ along a longitudinal direction denoted by L that is parallel to a reflective surface 2536. Mirror 2530 is positioned to be in contact with a first support surface 2521 and a second support surface 2522 of a cap body, such that the reflective surface 2536 has a tilt angle θ relative to the X-Y plane. In particular, mirror 2530 has a first point 2541 in direct physical contact with first support surface 2521 and a second point 2542 that is in direct physical contact with second support surface 2522. It should be appreciated that the three support surfaces 2521, 2522 and 2523 are illustrated as belong to separate components merely for illustrative purpose only and in embodiments of the present disclosure the three support surfaces may be connected by a unitary cap body such as cap body 1520.

According to an aspect, with a longer mirror having a longer length L₀, the distance along longitudinal direction L between first point 2541 and second point 2542 increases. Because second point 2541 remains in contact with the second contact surface 2522, the first point 2541 would slide upward along the first contact surface 2521 to accommodate the longer length L₀. As a result, the tilt angle θ increases. For similar reasons, if a shorter mirror is placed in contact with the second contact surface and the first surface 2521, the tilt angle θ would decrease. Therefore the mirror's tilt angle may be adjustable by replacing the mirror with a mirror of a longer or shorter length, without having to change the shape or dimension of the cap body.

In some embodiments, the first contact surface 2521 comprises a ramp surface that allows the first point 2541 of mirror 2530 to pivot around the second point 2542 with a change of mirror length L₀. The ramp surface may be planar, as shown in the example in FIG. 3A, although it is not a requirement and other shapes may be used.

In some embodiments, the second contact surface 2522 may be a curved surface that is concaved towards a center that is away from the mirror 2530 or second point 2542. In the example shown in FIG. 3A, second contact surface 2522 is a concave cylindrical surface, although it is not a requirement that second contact surface 2522 is cylindrical.

In the example shown in FIG. 3A, the reflective surface 2536 of mirror 2530 is also in direct physical contact with a third support surface 2523. The third support surface 2523 may be a curved surface that is concaved towards a center that is away from the mirror 2530, although it is not a requirement that the third support surface 2523 be shaped as shown in the example in FIG. 3A. The third support surface 2523 and second support surface 2522 defines a recess 2524 in between, and a corner of the mirror 2538 is wedged within the recess 2524, such that the mirror 2530 remains in contact with the second support surface 2522. Once mirror 2530 is disposed to be in contact with all three support surfaces 2521, 2522 and 2523, further movement of the mirror 2530 relative to the cap body is restricted and the mirror is able to maintain a stable tilt angle θ to deflect the incoming excitation light signal to a desired spot on the sensor chip.

FIG. 3B is a partial-cross sectional view diagram of a chip package showing construction of support surfaces for the mirror using a molded part, in accordance with some embodiments. FIG. 3B shows a partial view of a chip package 3000 that is similar in many aspects as chip package 1000.

Chip package 3000 includes a cap body 3520 that is a molded part. Cap body 3520 includes a first support surface 3521, second support surface 3522 and a third support surface 3523 formed of a unitary component. A mirror 3530 is disposed on the cap body and supported by the three support surfaces. Both second support surface 3522 and third support surface 3523 are curved surfaces that each is concaved towards a center that is away from the mirror 3530. Second support surface 3522 and third support surface 3523 collectively define a recess 3524 therebetween, with a corner 3538 of the mirror 3530 disposed in the recess 3524.

As shown, first support surface 3521 is a ramp surface. Mirror 3530 has a first point 3541 in contact with the ramp surface 3521, and a second point 3542 in contact with the second support surface 3522. Mirror 3530 is removable, for example when it is determined that a tilt angle of the mirror 3530 is not within a predetermined range and does not provide an appropriate right-angle coupling for an incoming excitation light signal to be deflected towards a desired spot on the sensor chip 1140. If the mirror is replaced with a mirror having a longer/shorter length L₀, the first point 3541 of the mirror would slide upward/downward along the ramp surface 3521, leaving to a larger/smaller tilt angle θ.

During manufacturing of the chip package 3000, the dimensions of the three support surfaces 3521, 3522, 3523 may not be exact between individual caps. This could be due to a variety of reasons such as manufacturing equipment tolerances and errors, and other possible factors. For example, in batch manufacturing where the cap body is constructed using molded parts, each molded cap body may have slightly different dimensions when different molds are used, or when a same mold is used at different environmental conditions. As a result of the variations in cap body dimensions, if a mirror of a same dimension is placed in the cap body of the cap, there may be variations in the mirror tilt angle between batch manufactured parts. Embodiments of the present disclosure permits the mirror to be removable and replaced with a mirror of different length to provide a calibrated tilt angle for each manufactured chip package. The effect is that a chip package's mirror tilt angle may be calibrated without having to adjust a dimension of any part of the cap body, thus reducing the time and cost for manufacturing the cap body in large quantity.

In some embodiments, the mirror is made of a material that can be economically manufactured at scale. In one example, the mirror is formed from a semiconductor material such as silicon. In some embodiments, a surface of the mirror configured to face the external light source can be coated or laminated with a reflective layer.

Still referring to FIG. 3B, the mirror 3530 may be pressed on a side opposing the first point 3541 by a retaining clip 3540 to hold the mirror 3530 in place without the mirror falling off when the chip package is flipped upside down or is subject to mechanical shock. Retaining clip may be secured in any suitable fashion on the cap body. In some embodiments, retaining clip 3540 may be installed during manufacturing process after an appropriate mirror has been selected and installed in the cap body to provide a calibrated tilt angle. After attaching the mirror and installation of the retaining clip, the retaining clip may remain in place for the life of the chip package assembly and the mirror is no longer removable.

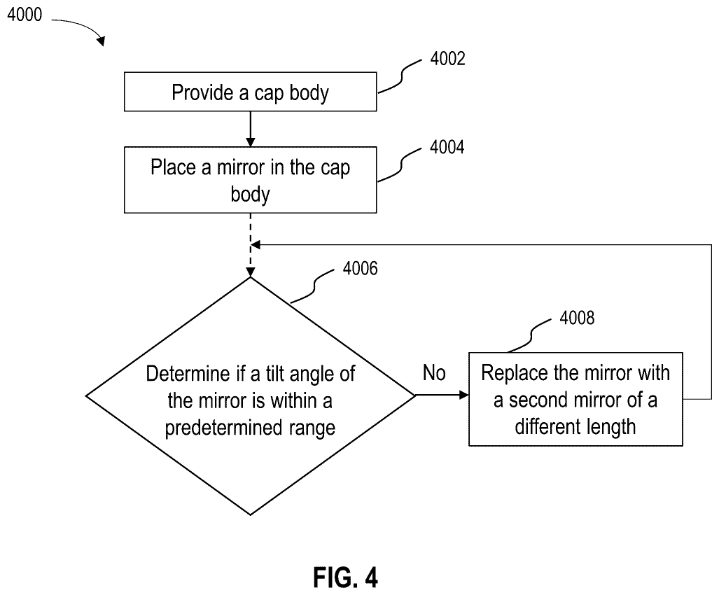

Some aspects relate to a method of manufacturing a cap for a sensor chip package. FIG. 4 is a flow chart of an exemplary manufacturing process for a cap that can be used in a sensor chip package, in accordance with some embodiments.

In the exemplary process 4000 as shown in FIG. 4, after a cap body or helmet is formed at block 4002, a first mirror may be placed in the cap body at block 4004. The first mirror may be supported by different support surfaces of the cap body. The cap body may be formed by any suitable manufacturing technique, such as by provided a molded part.

Optionally, at block 4006, a determination is made as to whether a tilt angle of the mirror is within a predetermined range. A tilt angle measurement may be performed on the first mirror as part of a calibration process. If it is determined at block 4006 that the tilt angle of the first mirror is outside a predetermined range, the first mirror may be removed and replaced with a second mirror of a different length at block 4008, to provide a different mirror tilt angle without having to alter the cap body. The tilt angle calibration and replacement of the installed mirror may be iterated repeatedly until the tilt angle is measured to be within the predetermined range, after which the cap may be attached to a sensor chip.

A tilt angle measurement for calibration purpose may be performed in any suitable ways to determine whether a deflected excitation light signal will arrive at a designated spot on the sensor chip. In a non-limiting example, a quad detector 320 such as that shown in FIG. 1E may be used to aid in alignment of the deflected excitation light signal.

In some embodiments, selection of a replacement mirror length may be guided by the amount of deviation the tilt angle of the first mirror is from a target tilt angle measured during calibration. For example, based on which direction the deviation is, a shorter or longer replacement mirror may be selected.

In some embodiments, a plurality of mirrors can be premade with lengths in increments, such as in a constant increment of 10 μm, 50 μm, 100 μm, or others. Although it's not a requirement that the mirror lengths have a constant increment. Smaller increments or less granularity in the premade mirror lengths tend to make tilt angle adjustment during manufacturing more accurate as there is a higher chance for finding a replacement mirror length that provides approximately the exact tilt angle. In some embodiments where the mirrors are formed of semiconductor material, the mirrors may be diced from a single semiconductor wafer in an array to produce a large quantity of mirrors each patterned to have a predetermined length.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately,” “substantially,” and “about” may be used to mean within ±20% of a target value and/or aspect in some embodiments, within ±10% of a target value in some embodiments, within ±5% of a target value in some embodiments, and yet within ±2% of a target value in some embodiments. The terms “approximately,” “substantially,” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. An apparatus, comprising:
a chip comprising a plurality of sample wells; and
a cap disposed on the chip and comprising an optical component configured to direct an excitation light signal for exciting samples within the plurality of sample wells of the chip.

2. A cap configured to engage a chip comprising a plurality of sample wells, the cap comprising:
a cap body; and
a mirror configured to deflect an excitation light signal for exciting samples within the plurality of sample wells of the chip.

3. The cap of claim 2, wherein:
the mirror is removably attached to the cap body.

4. The cap of claim 2, wherein:
the chip has a first surface facing the cap; and
the mirror is positioned to deflect an excitation light signal towards the first surface.

5. The cap of claim 4, wherein:
the excitation light signal is substantially parallel to the first surface.

6. The cap of claim 4, wherein:
the cap body comprises a first support surface in contact with a first point of the mirror and a second support surface in contact with a second point of the mirror.

7. The cap of claim 6, wherein the first support surface comprises a ramp surface, and the mirror is oriented at a tilt angle relative to the first surface of the chip that is configured to vary based on a length of the mirror between the first point and the second point of the mirror.

8. The cap of claim 6, wherein the cap body further comprises:
a third support surface in contact with a third point of the mirror;
a recess between the second support surface and the third support surface, wherein at least a portion of the mirror is disposed in the recess.

9. The cap of claim 6, further comprises a retaining clip configured to press the mirror against the first support surface and the second support surface.

10. The cap of claim 2, wherein the mirror comprises silicon.

11. The cap of claim 2, wherein the cap body comprises a polymer material.

12. The cap of claim 4, wherein the chip further comprises at least one waveguide and one or more grating couplers, the one or more grating couplers configured to optically couple the excitation light signal deflected by the mirror to the at least one waveguide for exciting samples.

13. A system for sequencing a sample, comprising:
a chip having a sample well configured to hold the sample;
a light source configured to produce an excitation light signal; and
a cap disposed on the chip and comprising a mirror configured to direct the excitation light signal for exciting the sample within the sample well.

14. The system of claim 13, wherein the light source comprises a pulsed laser source.

15. A method of manufacturing a cap configured to engage a chip having a plurality of sample wells, the method comprising:
providing a cap body; and
placing a mirror in the cap body, such that the mirror is configured to direct an excitation light signal for exciting samples within the plurality of sample wells of the chip.

16. The method of claim 15, further comprising:
determining if a tilt angle of the mirror is within a predetermined range; and
in response to a determination that the tilt angle is outside the predetermined range, replacing the mirror with a second mirror of a different length.

17. The method of claim 16, wherein determining if the tilt angle is within a predetermined range comprises:
receiving, at the mirror, an excitation light signal from a light source;
generating, by the mirror, a deflected light signal in response to receiving the excitation light signal; and
determining if the deflected light signal is within a predetermined location on the chip.

18. The method of claim 15, further comprising:
attaching a retaining clip to prevent the mirror from being removed from the cap body.

19. The method of claim 15, further comprising:
attaching the cap to the chip.
